(19) United States
(12) Patent Application Publication
(10) Pub. No.: US 2001/0013437 A1
(43) Pub. Date: Aug. 16, 2001

(54) Removable battery for powered chairs and the like

(76) Inventors: Royce H. Husted, Forest, VA (US); Joel P. Husted, Forest, VA (US)

Correspondence Address: Nicholas A. Camasto Ltd., 545 Thatcher, River Forest, IL, 60305, US

(21) Appl. No.: 09/815,791

(22) Filed: Mar. 23, 2001

Related U.S. Application Data
(63) Continuation-in-part of application No. 09/669,544, filed on Sep. 26, 2000.
Application No. 09/669,544 is a continuation-in-part of application No. 09/503,068, filed on Feb. 12, 2000.

(51) Int. Cl. B60R 16/04

(52) U.S. Cl. 180/65.1; 180/68.5

(57) ABSTRACT

A removable battery pack housing arrangement for a light-weight powered personal vehicle includes a first connector affixed to the battery pack housing. A U-shaped bracket is affixed to the vehicle frame and includes a vertical wall that secures a second connector so that the first connector and the second connector are brought into mating engagement when the battery pack housing is positioned on the bracket. The battery pack housing includes a handle for carrying, and a latch mechanism for securing, the battery pack housing in a precise location on the bracket.

### CROSS REFERENCE TO RELATED APPLICATION

This application is a continuation in part of application Ser. No. 09/669, 544, filed Sep. 26, 2000, entitled A STABLE POWERED TRICYCLE WITH TRACTION STEERING, which is a continuation-in-part of application Ser. No. 09/503,068, filed Feb. 12, 2000, entitled LIGHTWEIGHT MANEUVERABLE POWERED CHAIR.

### BACKGROUND OF THE INVENTION

This invention relates generally to battery powered chairs and scooters, hereinafter referred to collectively as vehicles, for transporting disabled people. Specifically the invention concerns an arrangement for rapidly and easily removing (and reinstalling) the vehicle battery, battery pack or battery pack housing for significantly reducing the weight of the vehicle for transportation in an automobile or the like. The terms battery, battery pack and battery pack housing are used interchangeably herein.

Powered chairs and scooters are bulky and heavy (generally weighing in the range of 150 to 250 pounds) and require special equipment to transport them Recently, some light-weight powered chairs weighing about 100 pounds have been marketed, but even these are far too heavy for most people to lift into the trunk of an automobile. Such powered chairs generally necessitate the use of a specially equipped van with a power lift, which is far too costly for most people.

Batteries for powered vehicles are very heavy, generally weighing at least as much as the vehicle frame. Further, the task of removal and installation of the battery requires tools, some skill and a significant amount of time. Also, there is always a danger in working with battery terminals and leads because of the very high current capability of the battery.

The present invention enables fast, easy and safe removal and installation of the vehicle battery pack, without the need for skill or tools. Since the battery pack comprises about fifty percent of the already low (about 50 pounds) weight of the vehicle described in the above-referenced copending applications, it is well within the ability of any ordinary individual to load (and unload) the separated vehicle and battery pack in the trunk of an automobile and to safely reinstall the battery pack, as needed. The result is a readily transportable powered chair or scooter.

### OBJECTS OF THE INVENTION

A principal object of the invention is to provide a novel battery powered vehicle with a readily and safely removable battery pack.

A further object of the invention is to provide a battery powered vehicle that may be readily transported in the trunk of an automobile or the like.

### BRIEF DESCRIPTION OF THE DRAWINGS

These and other objects and advantages of the invention will be apparent upon reading the following description in conjunction with the drawings in which:

FIG. 1 is a side elevation of the powered chair of the invention with the battery pack housing ready for installation;

FIG. 2 is a partial side elevation of the powered chair showing the battery pack housing aligned for installation; and

FIG. 3 is a partial plan view of the powered chair with the battery pack housing installed.

### DETAILED DESCRIPTION OF THE INVENTION

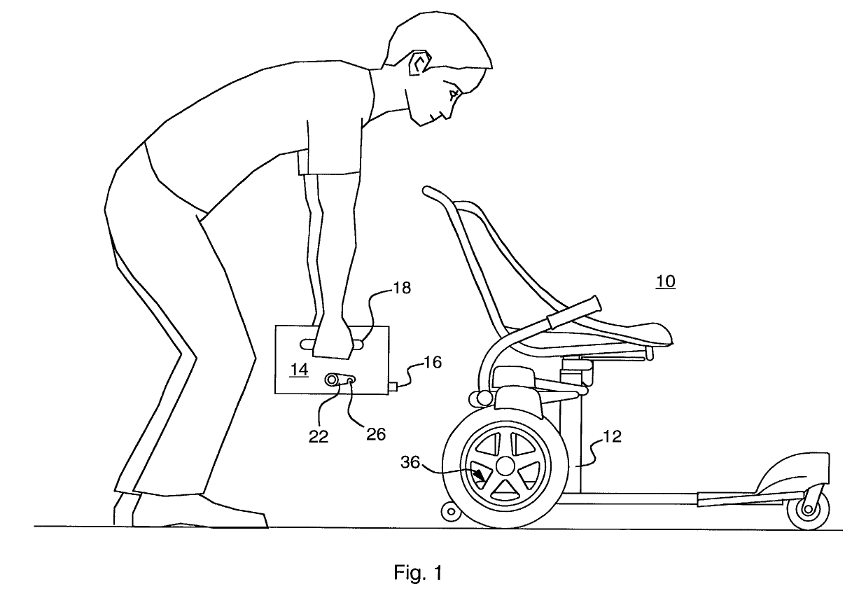

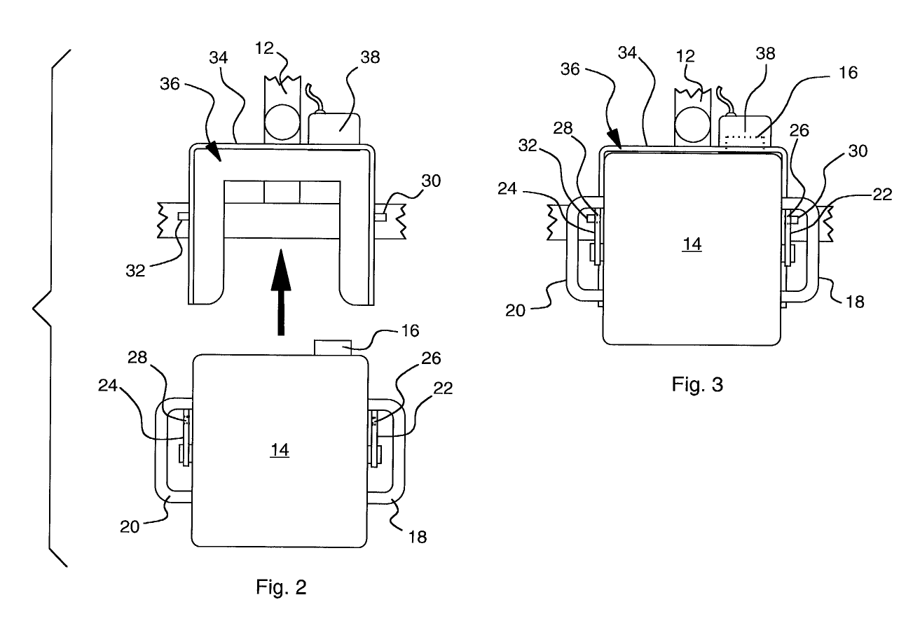

FIG. 1 depicts a light-weight powered chair substantially as shown in the above referenced copending applications. As mentioned above, the invention is not to be limited to a powered chair, but is generally applicable to all personal battery powered vehicles, such as wheelchairs and scooters. Reference to FIGS. 1-3 is made for the following description of the invention. A powered chair 10 includes a light-weight frame 12 that comprises wheels and drive components as fully described in the copending applications. A battery pack housing 14 houses one or more interconnected batteries (not shown) that are connected to a first electrical connector 15 that is supported in an end wall of battery pack housing 14. A pair of handles 18 and 20 is provided on opposite sides of housing 14 for enabling easy installation and removal of the battery pack housing 14. Two latches 22 and 24 are pivotally supported on opposite sides of battery pack housing 14 and include latching notches 26 and 28, respectively for cooperation with a corresponding pair of latching pins 30 and 32. Latches 30,32 are affixed to a vertical wall of a generally U shaped bracket 36 that supports the battery pack housing 14 on the vehicle. The latching pins 30,32 and the latching notches 26,28 insure that the battery pack housing 14 is secured in its operating position on bracket 36. The dimensions of the battery pack housing 14 and the U-shaped bracket 36 provide for a secure fit to preclude movement of the battery pack housing 14 and assure alignment between the contacts (not shown) of electrical connector 16 and the contacts (not shown) of a mating electrical connector 38 that is rigidly secured to vertical wall 34 by any convenient means.

The electrical connector 16 has its contacts shrouded within an insulating sheath to preclude accidental contact therewith during installation, removal and transportation of the battery pack housing 14. The contacts of mating connector 38 are set in a matching insulating block for proper mating with the contacts of connector 16. Any number of well-known types of mating male/female connectors may be utilized with the inventive apparatus, with the criterion being to preclude accidental access to the battery-connected contacts of the connector 16.

The battery pack housing 14 is readily removed by disengaging the locking latches 22,24 from the locking pins 30,32, grasping the battery pack housing 14 by its handles 18,20 and sliding the battery pack housing 14 to disengage the contacts of connector 16 from the contacts of connector 38. Installation of the battery pack housing 14 on the vehicle is the reverse of removal. When removed, the battery pack housing 14 may be placed in the trunk of an automobile along with the vehicle frame for transportation and readily reassemble, as required.

What has been described is a removable battery pack housing system for a light-weight powered vehicle that facilitates transportation of the vehicle in the trunk of an automobile. It is recognized that numerous changes to the described embodiment of the invention will be apparent to those skilled in the art without departing from its true spirit and scope. The invention is to be limited only as defined in the claims.

1. A system for facilitating the transport of a battery powered personal vehicle in the trunk of an automobile, said vehicle including a frame, wheels, motor, transmission and operating controls, comprising:
a first electrical connector, for coupling operating power to said vehicle, mounted on said frame;
a battery pack housing having a second electrical connector mounted thereon; and
a bracket affixed to said frame for supporting said battery pack housing in a precise location with respect to said first electrical connector; whereby
said first electrical connector and said second electrical connector are brought into mating engagement when said battery pack housing is installed in operating position on said bracket.

2. The system of claim 1, further including:
a latch mechanism for securing said battery pack housing to said bracket.

3. The system of claim 2, wherein said battery pack housing includes a handle for maneuvering and carrying said battery pack housing.

4. The system of claim 3, wherein said bracket comprises a U-shaped member having a vertical wall for securely nesting said battery pack housing therein.

5. A system for facilitating the transport of a battery powered personal vehicle in the trunk of an automobile, said vehicle including a frame, wheels, motor, transmission and operating controls, comprising:
a battery pack housing having a first connector mounted thereon;
a bracket affixed to said frame;
a second connector secured to said bracket for coupling operating power to said vehicle;
said bracket supporting said battery pack housing and said first connector in a precise location with respect to said second connector; and
a latch mechanism for securing said battery pack housing to said bracket, whereby
said first connector and said second connector are brought into mating engagement when said battery pack housing is installed in operating position on said bracket.

6. The system of claim 5, wherein said bracket comprises a U-shaped member having a vertical wall for securely nesting said battery pack housing therein.

7. The system of claim 7, wherein said battery pack housing includes a handle for maneuvering and carrying said battery pack housing.
